(19) United States
(12) Patent Application Publication
(10) Pub. No.: US 2025/0385635 A1
(43) Pub. Date: Dec. 18, 2025

(54) Integrated Roofing System for Renewable Energy Applications

(71) Applicant: Nanotronics Imaging, Inc., Cuyahoga Falls, OH (US)

(72) Inventors: John B. Putman, Celebration, FL (US); Matthew C. Putman, Brooklyn, NY (US)

(73) Assignee: Nanotronics Imaging, Inc., Cuyahoga Falls, OH (US)

(21) Appl. No.: 18/745,625

(22) Filed: Jun. 17, 2024

(51) Int. Cl. H02S 20/23; E04D 1/30

(52) U.S. Cl. CPC H02S 20/23; E04D 1/30; E04D 2001/308

(57) ABSTRACT

A roofing system for renewable energy applications and a method for installing the same are disclosed herein. The roofing system includes a roofing sub-structure, a plurality of openings, a channel, and a plurality of filler panels. The plurality of openings is formed in the roofing sub-structure. The channel is formed in the roofing sub-structure. The channel is configured to receive wiring. The plurality of filler is panels attached to the roofing sub-structure via the plurality of openings. The plurality of filler panels provides standard places for the addition of solar panels to the roofing system.

### FIELD OF DISCLOSURE

The present disclosure generally relates to an integrated roofing system for renewable energy applications.

### BACKGROUND

Roofing systems are a foundational aspect of any building structure, providing protection from weather elements and contributing to the overall structural integrity of the building. Traditional roofing systems typically consist of a sub-structure, which is often fabricated from materials such as wood or metal. This sub-structure forms the base upon which the rest of the roofing system is built.

Once the sub-structure is in place, a weatherproofing method is applied. This method can vary, but common approaches include the use of an EPDM (ethylene propylene diene terpolymer) membrane, shingles, or other similar materials. These weatherproofing methods serve to protect the underlying sub-structure and the interior of the building from water damage and other weather-related impacts.

In recent years, there has been a growing interest in renewable energy sources, particularly solar energy. This has led to the development of solar systems that can be integrated into roofing systems. These solar systems can take various forms, such as solar shingles that replace traditional shingles, or solar panels that are added to a finished roof. Regardless of the form, these solar systems convert sunlight into electricity, which can then be used to power the building.

Integrating solar systems into roofing systems requires additional infrastructure to be added to the roof and building structure. This infrastructure typically includes conduit to channel the wiring from the solar panels to the building's electrical circuit, a facility or structure to provide space for the inverters that convert the direct current produced by the solar panels into alternating current that can be used by the building, and access to the building's electrical panel.

While the integration of solar systems into roofing systems has many benefits, it also presents a number of challenges. These challenges include the complexity of the installation process, the potential for damage to the roof during installation, and the difficulty of adding additional solar panels to the system after the initial installation.

### SUMMARY OF INVENTION

In some embodiments, a roofing system for renewable energy applications is disclosed herein. The roofing system includes a roofing sub-structure, a plurality of openings, a channel, and a plurality of filler panels. The plurality of openings is formed in the roofing sub-structure. The channel is formed in the roofing sub-structure. The channel is configured to receive wiring. The plurality of filler is panels attached to the roofing sub-structure via the plurality of openings. The plurality of filler panels provides standard places for the addition of solar panels to the roofing system.

In some embodiments, a structure is disclosed herein. The structure includes a plurality of walls and a roofing system for renewable energy applications. The roofing system forms an upper covering for the plurality of walls. The roofing system includes a roofing sub-structure, a plurality of openings, a channel, and a plurality of filler panels. The plurality of openings is formed in the roofing sub-structure. The channel is formed in the roofing sub-structure. The channel is configured to receive wiring. The plurality of filler is panels attached to the roofing sub-structure via the plurality of openings. The plurality of filler panels provides standard places for the addition of solar panels to the roofing system.

In some embodiments, a method for installing a solar panel on a roofing system of a house is disclosed herein. The method includes removing a filler panel from a roofing sub-structure. Removing the filler panel from the roofing sub-structure exposes a terminal disposed in an opening formed in the roofing sub-structure. The terminal is configured to receive connections of a solar panel. The method further includes positioning the solar panel in the opening formed in the roofing sub-structure after the filler panel has been removed.

### BRIEF DESCRIPTION OF FIGURES

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a perspective view of a house with a roofing system, according to example embodiments.

FIG. 2 is a top view of the roofing system of the house of FIG. 1, according to example embodiments.

FIG. 3 is a partial side view of the roofing sub-structure of the roofing system of FIG. 2, according to example embodiments.

FIG. 4 is a partial side view of the roofing sub-structure of the roofing system of FIG. 2, according to example embodiments.

FIG. 5 is a flow diagram illustrating a method of installing a solar panel, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure relates to a roofing system designed for renewable energy applications. This system includes a roofing sub-structure, serving as the base onto which other elements of the system are attached or integrated. Roofing sub-structure can be constructed from a variety of materials, including wood, metal, composite materials, plastics, and ceramics. Choice of material may depend on factors such as cost, weight, durability, and environmental impact.

Attached to roofing sub-structure are filler panels, providing standardized spaces on the sub-structure for the addition of solar panels. Filler panels can be made from materials such as glass, plastic, or composite materials. Choice of material for filler panels can affect weight, durability, transparency, and ability to conduct heat. Design of filler panels can also vary to accommodate different types of solar panels, including thin-film solar panels, crystalline silicon solar panels, or solar tiles.

Within roofing sub-structure is a system of channeling, allowing for the routing of wiring for the addition of solar panels to roofing sub-structure. For example, a filler panel can be easily swapped out for a solar panel. The roofing sub-structure may include channeling configured to accommodate a variety of wiring types, including thick or thin wires, single or multiple wires, or even wireless connections, for connecting the solar panels. In some embodiments, the channeling can also accommodate different types of connectors, such as screw terminals, spring terminals, or plug-in connectors.

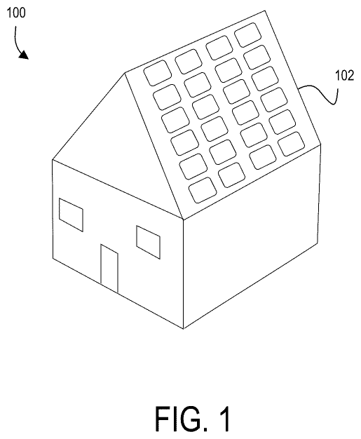

FIG. 1 is an isometric view of a house 100 with roofing system, according to example embodiments. As shown, house 100 may serve as the structural base for roofing system 102. Roofing system 102 may be designed to integrate with additional systems, potentially for the installation of solar panels or related renewable energy technology. Roofing system 102 may include a roofing sub-structure, which forms the base of roofing system 102. Roofing sub-structure may be designed to accommodate either standard or custom roofing technology, and it can be easily modified for the installation of solar panels.

Roofing system 102 is designed to be easily integrated with existing structure of house 100. This allows for seamless installation of solar panels, without the need for extensive modifications to structure of house.

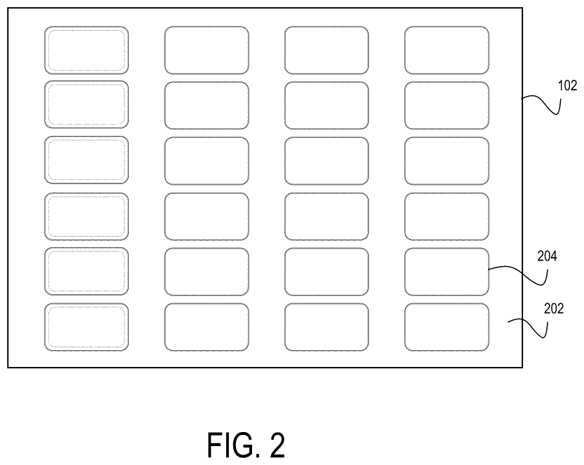

FIG. 2 is a top view of a panel of roofing system 102, according to example embodiments. As shown, roofing system 102 may include roofing sub-structure 202 and an arrangement of filler panels 204.

Roofing sub-structure 202 may be designed to provide a robust and durable platform for the installation of solar panels. For example, roofing sub-structure 202 may be designed to withstand the weight of filler panels and/or solar panels, as well as environmental conditions to which it may be exposed, such as wind, rain, and snow. Roofing sub-structure 202 can be constructed from a variety of materials, including wood, metal, composite materials, plastics, and ceramics. Choice of material may depend on factors such as cost, weight, durability, and environmental impact. Design of roofing sub-structure 202 can also vary to accommodate different types of roofing technologies, including standard and custom roofing technologies.

Filler panels 204 may be attached to roofing sub-structure 202. Filler panels 204 may provide standardized spaces for the addition of solar panels. Filler panels 204 can be made from materials such as glass, plastic, or composite materials. Choice of material for filler panels can affect weight, durability, transparency, and ability to conduct heat. Design of filler panels can also vary to accommodate different types of solar panels, including thin-film solar panels, crystalline silicon solar panels, or solar tiles. Design of filler panels 204 can also vary to accommodate different types of solar panels, including thin-film solar panels, crystalline silicon solar panels, or solar tiles. Filler panels 204 can be easily attached to or detached from roofing sub-structure 202, allowing for easy modification of roofing system.

As shown, roofing sub-structure 202 may form a foundational grid onto which filler panels 204 may be attached. Filler panels 204 may be systematically arranged within confines of roofing system 102. Filler panels 204 may be removably coupled with roofing sub-structure 202. This systematic arrangement of filler panels 204 may allow for a flexible and modular approach to installation of solar panels. For example, each filler panel 204 may be removable, such that a solar panel may be easily installed in its place. In this manner, roofing sub-structure 202 may allow users or operators to add or remove solar panels as per their energy requirements.

In some embodiments, roofing sub-structure 202 and filler panels 204 may be designed to integrate with other systems, such as home automation systems, energy management systems, or grid-tied systems. This integration can be achieved through a variety of methods, including wired or wireless connections, or even through software interfaces.

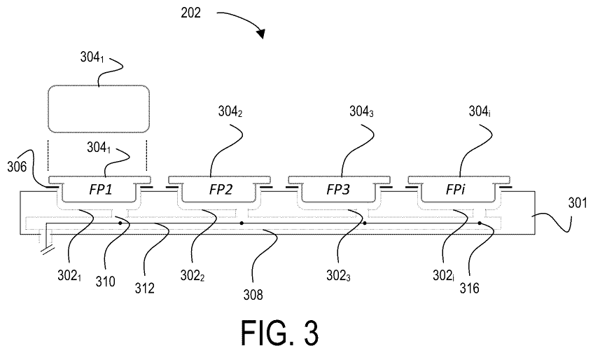

FIG. 3 is a partial side view of roofing sub-structure 202, according to example embodiments. Roofing sub-structure 202 may include a body 301. Body 301 may include a plurality of openings 302 and channel 308 formed therein. In some embodiments, openings 302 may be in fluid communication with channel 308. For example, access channels 310 may be used to fluidly connect openings 302 with channel 308.

Each opening 302 may be configured to receive a filler panel 304 or solar panel. For example, as shown, roofing sub-structure may include a plurality of filler panels 3041, 3042, 3043, and 304; positioned in a plurality of openings 3021, 3022, 3023, and 302;. In some embodiments, gaskets 306 may be positioned between the plurality of filler panels 304 and the plurality of openings 302.

Channel 308 may include wiring 312 disposed therein. Wiring 312 may be used to install solar panels in place of respective filler panels 304. For example, each opening 302 may include a terminal for facilitating a connection between solar panels and wiring 312. Such arrangement may facilitate connection of solar panels to roofing sub-structure 202.

Design of roofing sub-structure 202 can accommodate a variety of wiring types, including thick or thin wires, single or multiple wires, or even wireless connections. Channeling can also accommodate different types of connectors, such as screw terminals, spring terminals, or plug-in connectors. Design of channeling can be varied to accommodate different types of wiring, allowing for flexibility in installation of solar panels as well as contributing to the overall functionality and efficiency of roofing system 102.

In some embodiments, openings 302 may be designed to fit additional components, such as inverters or other electrical equipment. Design of the openings 302 can be varied to accommodate different types of equipment, allowing for flexibility in installation of solar panels.

In some cases, roofing sub-structure 202 may include additional features, such as physical locations for placement of inverters or end point terminal for on-site connection to structure's electrical system.

In some embodiments, roofing sub-structure 202 may include an end point terminal 316. End point terminal 316 may allow for on-site connection to a structure's electrical system. Design of end point terminal can accommodate a variety of electrical system types, including single-phase or three-phase electrical systems, or even direct current (DC) electrical systems. End point terminal can also accommodate different types of connectors, such as screw terminals, spring terminals, or plug-in connectors.

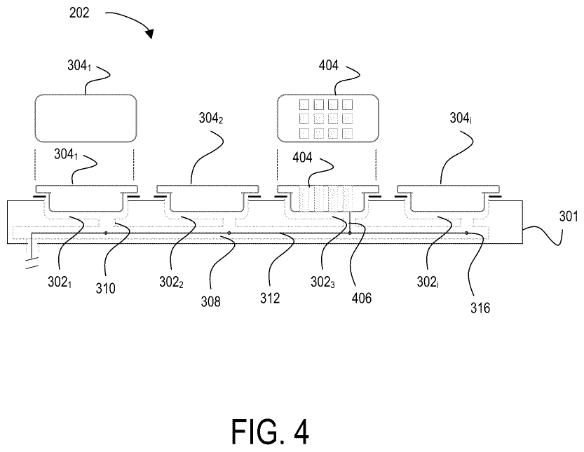

FIG. 4 is a partial side view of roofing sub-structure 202, according to example embodiments. Roofing sub-structure 202 is shown with an arrangement where multiple filler panels 304 are connected above respective openings 302 in roofing sub-structure 202.

As shown, a filler panel (e.g., filler panel 3043) has been replaced with a solar panel 404. Solar panel 404 may be seamlessly integrated into roofing sub-structure 202 by coupling solar panel 404 to terminals disposed in opening 302 (e.g., opening 3023) via photovoltaic wiring 406.

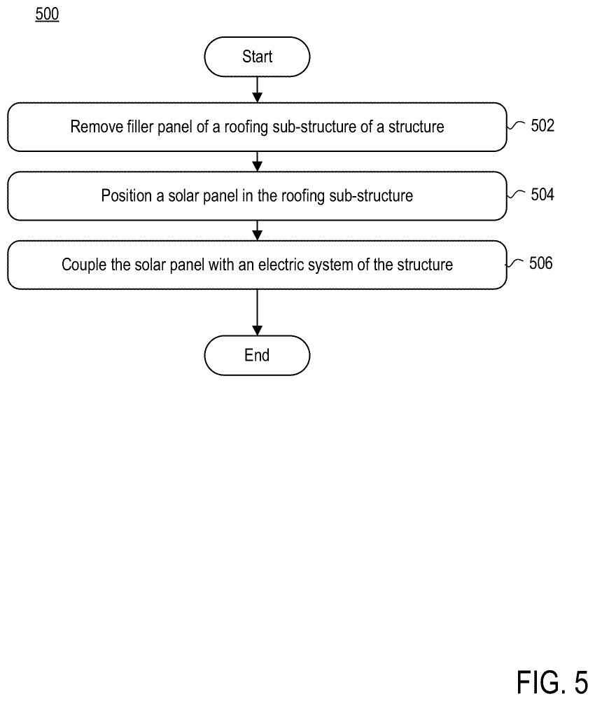

FIG. 5 is a flow diagram illustrating a method of installing a solar panel to a roofing system of a structure, according to example embodiments. Method 500 may begin at step 502.

At step 502, a filler panel of a roofing sub-structure may be removed. Removing the filler panel of the roofing sub-structure may reveal a terminal for receiving connections of a solar panel. The terminal may be coupled with wiring that runs through a channel formed in the roofing sub-structure. The wiring may include an end point terminal that allows for on-site connection to a structure's electrical system.

At step 504, a solar panel may be positioned in the roofing sub-structure. For example, the solar panel may be positioned in the opening formed from removing the filler panel from the roofing sub-structure.

At step 506, the solar panel may be coupled with the structure's electrical system. For example, connections of solar panel may be provided to the terminals in the corresponding opening of the roofing sub-structure. By connecting the solar panel to the terminal, the solar panel may be coupled with the structure's electrical system.

While the foregoing is directed to embodiments described herein, other and further embodiments may be devised without departing from the basic scope thereof. It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1. A roofing system for renewable energy applications, comprising:
a roofing sub-structure;
a plurality of openings formed in the roofing sub-structure;
a channel formed in the roofing sub-structure, the channel configured to receive wiring; and
a plurality of filler panels attached to the roofing sub-structure via the plurality of openings, the plurality of filler panels providing standard places for the addition of solar panels to the roofing system.

2. The roofing system of claim 1, further comprising:
a solar panel, wherein the solar panel replaces a filler panel of the plurality of filler panels.

3. The roofing system of claim 2, wherein the solar panel is coupled with the wiring disposed in the channel.

4. The roofing system of claim 2, wherein the solar panel is coupled with a terminal disposed in an opening corresponding to a location of the solar panel.

5. The roofing system of claim 2, wherein the solar panel is selected from a group comprising thin-film solar panels, crystalline silicon solar panels, or solar tiles.

6. The roofing system of claim 1, wherein the roofing sub-structure further comprises:
physical locations within the roofing sub-structure for placement of inverters.

7. The roofing system of claim 1, further comprising:
an end point terminal configured to connect the wiring to an electrical system.

8. The roofing system of claim 1, further comprising:
a plurality of access channels, the plurality of access channels fluidly coupling the plurality of openings to the channel.

9. The roofing system of claim 1, further comprising:
a plurality of gaskets positioned between the plurality of openings and the plurality of filler panels.

10. A structure, comprising:
a plurality of walls; and
a roofing system for renewable energy applications, the roofing system forming an upper covering for the plurality of walls, the roofing system comprising:
a roofing sub-structure;
a plurality of openings formed in the roofing sub-structure;
a channel formed in the roofing sub-structure, the channel configured to receive wiring; and
a plurality of filler panels attached to the roofing sub-structure via the plurality of openings, the plurality of filler panels providing standard places for the addition of solar panels to the roofing system.

11. The structure of claim 10, further comprising:
a solar panel, wherein the solar panel replaces a filler panel of the plurality of filler panels.

12. The structure of claim 11, wherein the solar panel is coupled with the wiring disposed in the channel.

13. The structure of claim 11, wherein the solar panel is coupled with a terminal disposed in an opening corresponding to a location of the solar panel.

14. The structure of claim 11, wherein the solar panel is selected from a group comprising thin-film solar panels, crystalline silicon solar panels, or solar tiles.

15. The structure of claim 10, wherein the roofing sub-structure further comprises:
physical locations within the roofing sub-structure for placement of inverters.

16. The structure of claim 10, further comprising:
an end point terminal configured to connect wiring to an electrical system of the structure.

17. The structure of claim 10, further comprising:
a plurality of access channels, the plurality of access channels fluidly coupling the plurality of openings to the channel.

18. The structure of claim 10, further comprising:
a plurality of gaskets positioned between the plurality of openings and the plurality of filler panels.

19. A method for installing a solar panel on a roofing system of a house, the method comprising:
removing a filler panel from a roofing sub-structure, wherein removing the filler panel from the roofing sub-structure exposes a terminal disposed in an opening formed in the roofing sub-structure, the terminal configured to receive connections of a solar panel; and
positioning the solar panel in the opening formed in the roofing sub-structure after the filler panel has been removed.

20. The method of claim 19, further comprising:
coupling the solar panel to an electrical system of the house by connecting the solar panel to the terminal.
